(19) United States
(12) Patent Application Publication
(10) Pub. No.: US 2016/0125822 A1
(43) Pub. Date: May 5, 2016

(54) FIELD SEQUENTIAL LIQUID CRYSTAL DISPLAY DEVICE AND DRIVING METHOD THEREOF

(71) Applicant: SHENZHEN CHINA STAR OPTOELECTRONICS TECHNOLOGY CO., LTD., Guangdong (CN)

(72) Inventors: Chih Tsung KANG, Guangdong (CN); YONG FAN, Shenzhen (CN)

(73) Assignee: Shenzhen China Star Optoelectronics Technology Co., Ltd., Shenzhen (CN)

(21) Appl. No.: 14/416,845

(22) PCT Filed: May 28, 2014
(86) PCT No.: PCT/CN2014/078679

§ 371 Date: Jan. 23, 2015

(30) Foreign Application Priority Data
May 8, 2014 (CN) 201410193038.5

(51) Int. Cl. G09G 3/36; G09G 3/20

(52) U.S. Cl. CPC G09G 3/3614; G09G 3/2003; G09G 2310/08

(57) ABSTRACT

The present disclosure discloses a field sequential liquid crystal display device and a method for driving the same. The method comprises: providing a color field sequential signal, so that a backlight module generates a plurality of color fields in one frame period; providing, when each of the color fields is valid, a data driving signal to each sub-pixel unit of a pixel so as to activate the sub-pixel units corresponding to a respective color field; wherein the polarity of the data driving signal is periodically reversed, so that voltage waveform of the data driving signal is symmetrical relative to a common reference voltage.

### CROSS-REFERENCE TO RELATED APPLICATION

This application claims benefit of Chinese Patent Application No. 201410193038.5 entitled “Field sequential liquid crystal display device and driving method thereof”, filed in May 8, 2014, the disclosure of which is incorporated by reference herein in its entirety.

### FIELD OF THE INVENTION

The present disclosure relates to the technical field of displaying, in particular to a method for driving a field sequential liquid crystal display and a display device.

### BACKGROUND OF THE INVENTION

Currently, a field sequential color LCD (Field Sequential Color LCD, FSC-LCD) does not need a color filter but, instead, a backlight module for providing color fields of red, green and blue respectively to display three-color (i.e., red, green and blue) image information in terms of time sequence. As a result, a multicolor image can be displayed, by virtue of a visual persistence property of human eyes, on the retina of human through a time based color mixing method. Therefore, the FSC-LCD has the advantages of high light-emitted efficiency, high resolution and low cost, and thus becomes the main trend of development for LCD.

Generally, if liquid crystal molecules keep operating in a certain fixed voltage for a long term, the characteristic of the liquid crystal molecules would be immobilized. After the fixed voltage is removed, the liquid crystal molecules are impossible to respond to the change of an applied voltage. Therefore, a driving manner for the liquid crystal of the LCD typically adopts alternating current for driving.

As for the FSC-LCD, a reversal manner of “every color field reversing once” is generally adopted, namely the polarity of a data voltage applied at two ends of the liquid crystal is reversed to some degree in terms of the color fields of red, green and blue respectively. However, when images of odd fields and of even fields are displayed, the absolute of the data voltage of positive applied to the ends of the liquid crystal is different from that of the data voltage of negative. Thus, the liquid crystal molecules are forced into a state of direct current bias. If a static picture is displayed for a long time, the liquid crystal may be excessively polarized and lose its rotating capability. As a result, when other pictures are displayed, the liquid crystal can not rotate in a normal may, and thus residual images are formed.

Therefore, a field sequential liquid crystal display device capable of eliminating residual images and a method for driving the same are urgently needed.

### SUMMARY OF THE INVENTION

Aiming at the above problems in the prior art, the present disclosure provides a method capable of eliminating residual images for driving a field sequential liquid crystal display. The method comprises the steps of:

providing a color field sequential signal, so that a backlight module generates a plurality of color fields in one frame period;

providing, when each of the color fields is valid, a data driving signal to each sub-pixel unit of a pixel so as to activate the sub-pixel units corresponding to a respective color field;

wherein the polarity of the data driving signal is periodically reversed, so that voltage waveform of the data driving signal is symmetrical relative to a common reference voltage.

According to one embodiment of the present disclosure, two color fields are generated in one frame period. When a first color field is valid, a first part of the data driving signal is provided to each sub-pixel unit of a pixel to activate each of the sub-pixel units, so that light of the first color field can penetrate through the sub-pixel units. When a second color field is valid, a second part of the data driving signal is provided to each sub-pixel unit of a pixel to activate one or each of the sub-pixel units, so that light of the second color field can penetrate through the activated sub-pixel units. The first part and second part of the data driving signal have the same polarity.

According to one embodiment of the present disclosure, the duration when the first color field is valid is the same as the duration when the second color field is valid.

According to one embodiment of the present disclosure, a period of reversing polarity of the data driving signal is a multiple of the frame period.

According to one embodiment of the present disclosure, a period of reversing polarity of the data driving signal is the same as the frame period.

According to one embodiment of the present disclosure, the polarity of the data driving signal is periodically reversed under the control of a polarity reversion control signal.

According to one embodiment of the present disclosure, at least one of the sub-pixel units is a transparent sub-pixel unit.

According to one embodiment of the present disclosure, the sub-pixel units include two of a magenta sub-pixel unit, a cyan sub-pixel unit, and a yellow sub-pixel unit; or, the sub-pixel units include two of a red sub-pixel unit, a green sub-pixel unit, and a blue sub-pixel unit.

According to one embodiment of the present disclosure, the backlight module emits white light under the first color field, and emits one of red light, blue light and green light under the second color field; or, the backlight module emits one of magenta light, cyan light and yellow light under the first color field, and emits one of red light, blue light and green light under the second color field.

According to another aspect of the present disclosure, a liquid crystal display device is further provided, which comprises:

a time sequence control unit, for providing a color field sequential signal so that a backlight module generates a plurality of color fields in one frame period; and

a data driving unit, for providing, when each of the color fields is valid, a data driving signal, to each sub-pixel unit of a pixel so as to activate the sub-pixel units corresponding to a respective color field;

wherein the time sequence control unit also provides a polarity reversion control signal for periodically reversing the polarity of the data driving signal, so that voltage waveform of the data driving signal is symmetrical relative to a common reference voltage.

According to one embodiment of the present disclosure, the backlight module generates two color fields in one frame period. When a first color field is valid, the data driving unit provides a first part of the data driving signal to each sub-pixel unit of a pixel to activate each of the sub-pixel units, so that light of the first color field can penetrate through the sub-pixel units. When a second color field is valid, the data driving unit provides a second part of the data driving signal to each sub-pixel unit of a pixel to activate one or each of the sub-pixel units, so that light of the second color field can penetrate through the activated sub-pixel units. The first part and second part of the data driving signal have the same polarity.

According to one embodiment of the present disclosure, the duration when the first color field is generated by the backlight module is the same as the duration when the second color field is generated by the backlight module.

According to one embodiment of the present disclosure, a period in which the polarity of the data driving signal is reversed under the polarity reversion control signal is a multiple of the frame period.

According to one embodiment of the present disclosure, the period in which the polarity of the data driving signal is reversed under the polarity reversion control signal is the same as the frame period.

According to one embodiment of the present disclosure, at least one of the sub-pixel units is a transparent sub-pixel unit.

According to one embodiment of the present disclosure, the sub-pixel units include two of a magenta sub-pixel unit, a cyan sub-pixel unit, and a yellow sub-pixel unit; or, the sub-pixel units include two of a red sub-pixel unit, a green sub-pixel unit, and a blue sub-pixel unit.

The driving method according to the present disclosure can realize a reversion of “every two color fields reversing once”. The polarities of data voltage of the sub-pixel units are the same in multiple color fields of each frame, and in either color field of the adjacent frames, the polarity of data voltage of each sub-pixel unit is reversed from one frame to the other. The positive data voltage and negative the data voltage which are respectively applied to both ends of the liquid crystals are identical with each other in terms of their absolute values. Therefore, residual images can be eliminated.

Other features and advantages of the present disclosure will be set forth in the following description, and are partially obvious from the description or understood by implementing the present disclosure. The objectives and other advantages of the present disclosure may be achieved and obtained by structures particularly specified in the description, the claims and the accompanying drawings.

### BRIEF DESCRIPTION OF THE DRAWINGS

The accompanying drawings are used to provide a further understanding of the present disclosure, and constitute a part of the description for explaining the present disclosure together with embodiments, without limiting the present disclosure. In the accompanying drawings.

FIG. 1 is a schematic diagram of structure of a field sequential liquid crystal display device according to embodiment 1 of the present disclosure;

FIG. 2 is a schematic diagram of structure of a pixel unit according to embodiment I of the present disclosure;

FIG. 3 is a time sequence diagram of signals related to the field sequential liquid crystal display device according to embodiment I of the present disclosure;

FIG. 4 is a flow chart of a method for driving the field sequential liquid crystal display device according to embodiment I of the present disclosure;

FIG. 5 is a schematic diagram of structure of a pixel unit according to embodiment II of the present disclosure;

FIG. 6 is a time sequence diagram of signals related to a field sequential liquid crystal display device according to embodiment II of the present disclosure;

FIG. 7 is a flow chart of a method for driving the field sequential liquid crystal display device according to embodiment II of the present disclosure; and

FIG. 8 is a schematic diagram of a reversal driving manner of a FSC-LCD according to embodiment III of the present disclosure.

### DETAILED DESCRIPTION OF THE EMBODIMENTS

In order to present the objectives, technical solutions and advantages of the present disclosure more apparently, a further detailed illustration to the present disclosure will be made below in combination with the accompanying drawings.

Embodiment I

FIG. 1 schematically shows the structure of a field sequential liquid crystal display device according to the present embodiment. As shown in FIG. 1, the liquid crystal display device 100 includes a display panel 110, a scan driving unit 120, a data driving unit 130, an image analyzing unit 140, a time sequence control unit 150, a main control unit 160, and a bacldight module 170. The backlight module 170 is arranged at the rear of the display panel 110 to provide a light source for the display panel 110. The display panel 110 includes a plurality of pixels 112 arranged in a matrix form, and each of the plurality of pixels 112 includes a plurality of sub-pixel units. Moreover, the backlight module 170 in this embodiment includes a white backlight (W) and a red backlight (R), which are not shown in FIG. 1.

The scan driving unit 120 and the data driving unit 130 are electrically connected to the display panel 110 respectively. The time sequence control unit 150 is electrically connected to the scan driving unit 120 and the data driving unit 130, so as to control the scan driving unit 120 to scan the display panel 110, and to control the data driving unit 130, by means of the main control unit 160, to drive the display panel 110 to display images.

The image analyzing unit 140 is electrically connected to the time sequence control unit 150, and configured to decompose each frame of image into a first image data and a second image data. In this embodiment, when the white backlight (W) emits light, a first part of a data driving signal is provided to the plurality of sub-pixel units in a pixel 112 to display the first image data; and when the red backlight (R) emits light, a second part of the data driving signal is provided to the plurality of sub-pixel units in the pixel 112 to display the second image data.

The time sequence control unit 150 may generate a periodic polarity reversion control signal POL for reversing the polarity of data voltage of a sub-pixel unit in the liquid crystal display panel. In this embodiment, the backlight module 170 generates two color fields in each frame period. In one single frame period, the data voltage in the first part of the data driving signal for the plurality of sub-pixel units in the pixel 112 is identical with the data voltage of the second part of the data driving signal. In two adjacent frame periods, the polarity of data voltage for each of the sub-pixel units is reversed once.

The main control unit 160 is electrically connected with the backlight module 170, and is configured to control the white backlight (W) and the red backlight (R) to emit light in an alternate manner. The backlight module 170, according to a color field sequential signal FS from the main control unit 160, can emit white (W) light synchronous with the first part of the data driving signal, or emit red (R) light synchronous with the second part of the data driving signal.

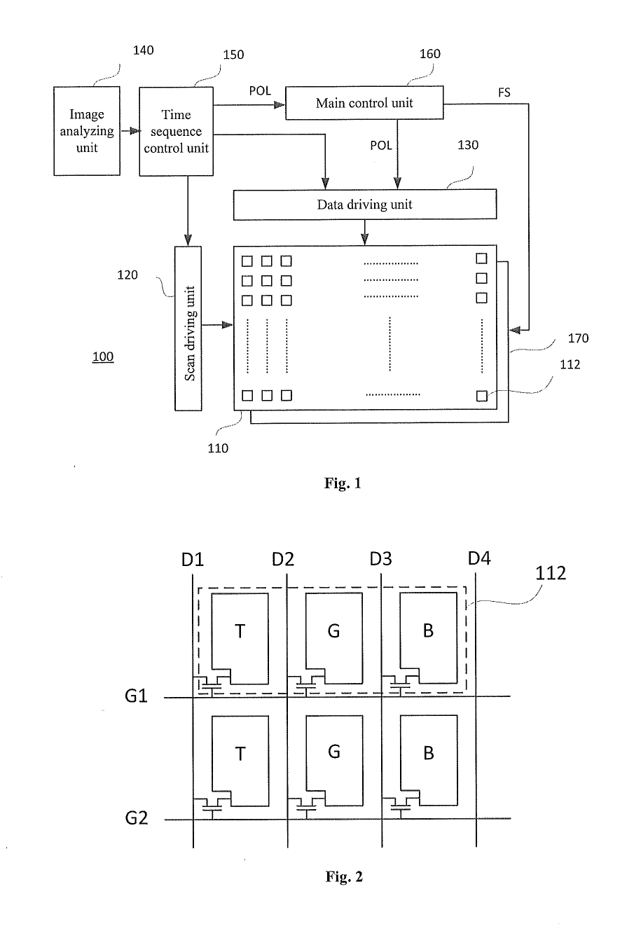

FIG. 2 schematically shows the structure of a pixel unit in this embodiment. As shown in FIG. 2, the pixel 112 includes three sub-pixel units arranged in parallel, which are respectively a transparent sub-pixel unit (T), a green sub-pixel unit (G) and a blue sub-pixel unit (B). In this case, the transparent sub-pixel unit (T) can transmit light of all wavelengths, the green sub-pixel unit (G) can transmit light of wavelengths of green, and the blue sub-pixel unit (B) can transmit light of wavelengths of blue. Under the control of the scan driving unit 120, gate lines G1 and G2 sequentially gate their respective rows of pixel units by means of scanning, so that the transparent sub-pixel unit (T), the green sub-pixel unit (G) and the blue sub-pixel unit (B) receive, respectively, data voltages from the data driving unit 130 via data lines D1, D2 and D3.

FIG. 3 is a time sequence diagram of signals related to the field sequential liquid crystal display device in the present embodiment. The polarity reversion control signal POL takes two frame periods as one driving period, and the backlight module 170 generates a first color field and a second color field in each frame period respectively. In the N^{th} frame and the (N+1)^{th} frame of said driving period, the polarity of data voltage of a sub-pixel unit during the N^{th} frame is opposite to that during the (N+1)^{th} frame, so that a period of reversing the polarity of data driving signal of the sub-pixel unit is synchronized with the frame period. That is, the polarity of the data driving signal of the sub-pixel unit is reversed once every frame period.

It should be noted that the period of reversing the polarity of data driving signal may be an integral multiple of the frame period.

When the polarity reversion control signal POL is a high level signal, the polarity of data voltage of each of the sub-pixel units is positive, namely the value of the data voltage is higher than that of voltage of a common electrode. When the polarity reversion control signal POL is a low level signal, the polarity of data voltage signal of each of the sub-pixel units is negative, namely the value of the data is lower than that of voltage of the common electrode. Thus, under the control of the polarity reversion control signal POL, the polarities of data voltage of the sub-pixel units in the liquid crystal display panel are periodically reversed, so that voltage waveform of the data voltage is symmetrical relative to a common reference voltage. In the N^{th} frame, the polarity of data voltage of a sub-pixel unit is positive, while in the (N+1)th frame, the polarity of data voltage of the sub-pixel unit is negative.

As shown in FIG. 3, a color field sequential signal FS provided in this embodiment is a periodic square wave signal, with a frame period as one driving period. When the color field sequential signal FS is of high level, the backlight module 170 generates a white-light color field; and when the color field sequential signal FS is of low level, the backlight module 170 generates a red-light color field. In this embodiment, the white-light color field and the red-light color field have the same valid time. That is to say, the white bacldight (W) and the red backlight (R) in the backlight module 170 have the same light emitting time.

Further, as shown in FIG. 3, in one single same frame, the polarity of data voltage of the first color field in each sub-pixel unit is identical with that of the second color field. In either the first color field or the second color field of two adjacent frames, the polarity of data voltage of each sub-pixel unit is opposite from one frame to the other.

Specifically, when the color field sequential signal FS is of high level, the white backlight (W) in the backlight module 170 emits light, so that the white-light color field is valid, and the data driving unit 130 drives the plurality of sub-pixel units in the pixel 112, according to the first part of the data driving signal, to display the first image data. When the color field sequential signal FS is of low level, the red bacldight (R) in the backlight module 170 emits light, so that the red-light color field is valid, and the data driving unit 130 drives the plurality of sub-pixel units in the pixel 112, according to the second part of the data driving signal, to display the second image data.

Therefore, in the two color fields of the same frame, the plarity of data voltage of each sub-pixel unit is not reversed. Moreover, in the color fields of two adjacent frames, the polarity of data voltage of each sub-pixel unit is reversed with respect to each other. Thus, a polarity reversion of “every two color fields reversing once” is formed, so that waveform of the data voltage of each sub-pixel unit is symmetrical relative to a common reference voltage, and the positive data voltage and negative the data voltage which are respectively applied to both ends of the liquid crystals are identical with each other in terms of their absolute values. Therefore, residual images can be eliminated.

An example regarding the polarity of data voltage of each sub-pixel unit in the pixel 112 in different frames is taken below for illustration .

In the first color field of the N^{th} frame, the polarity reversion control signal POL is of high level, and the data voltages of the transparent sub-pixel unit (T), the green sub-pixel unit (G) and the blue sub-pixel unit (B) are all of positive polarity. Meanwhile, the color field sequential signal FS is of high level, and thus the white back-light (W) in the backlight module 170 emits light. Then, the data driving unit 130 drives the plurality of sub-pixel units in the pixel 112, according to the first part of the data driving signal, to display the first image data with a data voltage of positive polarity. In this case, the first image data comprises a white image data, a green image data, and a blue image data. In particular, white back light penetrates through the transparent sub-pixel unit (T) to display the white image data. Moreover, the white back light penetrates through the green sub-pixel unit (G) to display the green image data. Further, the white back light penetrates through the blue sub-pixel unit (B) to display the blue image data.

Next, in the second color field of the N^{th} frame, the polarity reversion control signal POL is still of high level. Therefore, the data voltages of the transparent sub-pixel unit (T), the green sub-pixel unit (G) and the blue sub-pixel unit (B) are all of positive polarity. Meanwhile, the color field sequential signal FS is of low level, and the red backlight (R) in the backlight module 170 emits light. Then, the data driving unit 130 drives the plurality of sub-pixel units in the pixel 112, according to the second part of the data driving signal, to display the second image data with using the data voltage of positive polarity. In this case, the second image data comprises a red image data and a black image data. In particular, red back light penetrates through the transparent sub-pixel unit (T) to display the red image data. Moreover, both the green sub-pixel unit (G) and the blue sub-pixel unit (B) display the black image data.

As a result, in the N^{th} frame, the display panel 110 may display pictures of white, green, blue and red colors. Due to the visual persistence property of human eyes, a user may observe a multicolor display picture.

Further, in the first color field of the (N+1)^{th} frame, the polarity reversion control signal POL is of low level, and the data voltages of the transparent sub-pixel unit (T), the green sub-pixel unit (G) and the blue sub-pixel unit (B) are all of negative polarity. Meanwhile, the color field sequential signal FS is of high level, and the white backlight (W) in the backlight module 170 emits light. Then, the data driving unit 130 drives the plurality of sub-pixel units in the pixel 112, according to the first part of the data driving signal, to display the first image data with a data voltage of negative polarity. In this case, the first image data is displayed in the same manner as in the first color field of the N^{th} frame, and it will not be further described herein.

Next, in the second color field of the (N+1)^{th} frame, the polarity reversion control signal POL is still of low level. Therefore, the data voltages of the transparent sub-pixel unit (T), the green sub-pixel unit (G) and the blue sub-pixel unit (B) are all of negative polarity. Meawhile, the color field sequential signal FS is of low level, and the red backlight (R) in the backlight module 170 emits light. Then, the data driving unit 130 drives the plurality of sub-pixel units in the pixel 112, according to the second part of the data driving signal, to display the second image data with the data voltage of negative polarity. In this case, the second image data is displayed in the same manner as in the second color field of the (N+1)^{th} frame, and it will not be further described herein.

Thus, in the (N+1)^{th} frame, the display panel 110 may display pictures of white, green, blue and red. Due to the visual persistence property of human eyes, a user may watch a multicolor display picture.

In conclusion, the _{N}th (N+1)^{th} frame and the frame constitute a driving period of the polarity reversion control signal POL, wherein the polarity reversion control signal POL in the N^{th} frame is configured to be reversed in the (N+1)^{th} frame, so that the polarities of data voltage of the plurality of sub-pixel units in the pixel 112 are reversed. Two color fields are generated in each frame period. Moreover, in the two color fields of each frame, the polarities of data voltage in the sub-pixel unit are unchanged. Thus, a polarity reversion of “every two color fields reversing once” is formed.

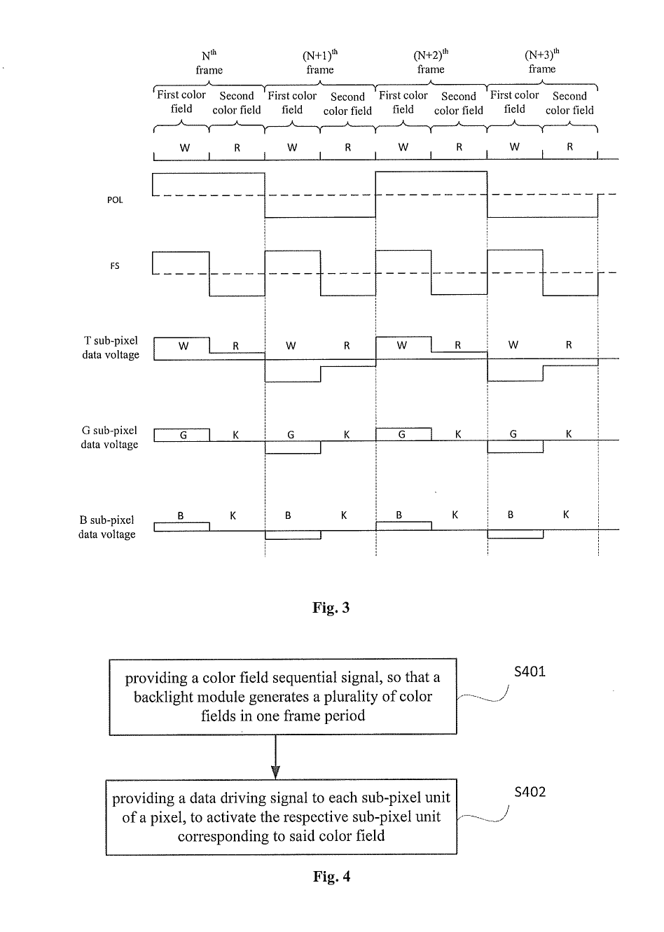

FIG. 4 is a flow chart of a method for driving the field sequential liquid crystal display device according to the embodiment. The driving method of this embodiment will be described in detail below in combination with FIG. 4.

Firstly, in step S401, a color field sequential signal FS is provided, so that the backlight module 170 generates a plurality of color fields in one frame period respectively. In this embodiment, the backlight module 170 provides a white-light color field and a red-light color field in one frame period.

Then, in step S402, a data driving signal is provided to each sub-pixel unit of the pixel 112 when a respective color field is valid, so as to activate the sub-pixel units corresponding to the respective color field. The polarity of the data driving signal is periodically reversed, so that the voltage waveform of the data driving signal is symmetrical relative to a common reference voltage. In paticular, the pixel 112 in this embodiment includes a transparent sub-pixel unit (T), a green sub-pixel unit (G) and a blue sub-pixel unit (B). Since the detailed driving process is described above, no further description will be provided herein.

The driving method of this embodiment enables the display panel 110 to display pictures of red, green and blue. Due to the visual persistence property of human eyes, a user may observe a multicolor display picture. Meanwhile, the driving method of this embodiment may realize a reversion of “every two color fields reversing once”. That is, in the two color fields of each frame, the polarities of data voltage in a sub-pixel unit are identical from one field to the other, and in either color field of two adjacent frames, the polarity of data voltage of each sub-pixel unit is reversed from one frame to the other. As a result, the positive data voltage and negative the data voltage which are respectively applied to both ends of the liquid crystals are identical with each other in terms of their absolute values, so that residual images may be eliminated.

Those skilled in the art may understand that, a structure of T-G-B sub-pixel units of a pixel unit and an arrangement comprising the white back light and the red back light in this embodiment may be implemented in other similar manners. For example, the pixel unit can use a structure of R-T-B sub-pixel units, and at the same time, the white back light and green back light can be used in an alternate manner. Alternatively, the pixel unit can use a R-G-T structure, and at the same time, the white back light and blue back light can be used in an alternate manner.

For another example, the pixel unit can use a structure of T-M-Y sub-pixel units, namely, each pixel unit includes a transparent sub-pixel unit (T), a magenta sub-pixel unit (M), and a yellow sub-pixel unit (Y). Meawhile, the backlight can use the white back light and cyan back light (C). Alternatively, the pixel unit can use a structure of C-M-T sub-pixel units, and at the same time, the white back light and yellow back light (Y) can be used in an alternate manner. Or, the pixel unit can use a C-T-Y structure, and at the same time, the white back light and magenta back light (M) can be alternatively used.

### Embodiment II

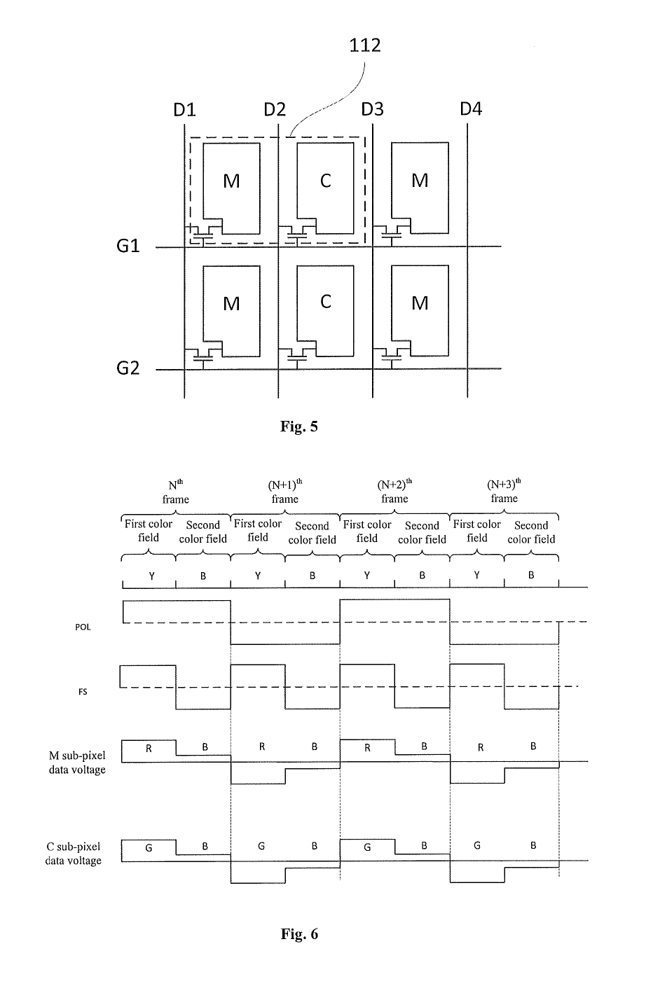

The present embodiment is substantially similar to embodiment I. The difference between this embodiment and embodiment I lies in that, as shown in FIG. 5, a pixel 112 in this embodiment includes two sub-pixel units arranged in parallel, which are respectively a magenta sub-pixel unit (M) and a cyan sub-pixel unit (C). Moreover, the backlight module 170 in this embodiment includes a yellow backlight (Y) and a blue backlight (B).

In this case, the yellow back light penetrates through the magenta sub-pixel unit (M) to display a red (R) image, and penetrates through the cyan sub-pixel unit (C) to display a green (G) image. The blue back light can penetrate through either the magenta sub-pixel unit (M) or the cyan sub-pixel unit (C) to display a blue image.

Therefore, the image analyzing unit 140 in this embodiment is configured to decompose each frame of image into a first image data and a second image data. In this embodiment, when the yellow backlight (Y) emits light, a first part of a data driving signal is provided to a plurality of sub-pixel units in the pixel 112, so as to display the first image data; and when the blue backlight (B) emits light, a second part of the data driving signal is provided to the plurality of sub-pixel units in the pixel 112, so as to display the second image data. In this case, the first image data includes a red image data and a green image data, and the second image data includes a blue image data.

It should be noted that, both the first image data and the second image data in this embodiment do not include a black image data.

FIG. 6 is a time sequence diagram of signals related to a field sequential liquid crystal display device in this embodiment. The relationship between the polarity reversion control signal POL and the color field sequential signal FS in this embodiment is the same as that of embodiment I, and it will not be further described herein.

In the first color field of the N^{th} frame, the polarity reversion control signal POL is of high level, and the data voltages of both the magenta sub-pixel unit (M) and the cyan sub-pixel unit (C) are of positive polarity. Meanwhile, the color field sequential signal FS is of high level, and the yellow backlight (Y) in the backlight module 170 emits light. Then, the data driving unit 130 drives the plurality of sub-pixel units in the pixel 112, according to the first part of the data driving signal, to display the first image data with the data voltage of positive polarity. In this case, the first image data comprises the red image data and the green image data. In paticular, the yellow back light penetrates through the magenta sub-pixel unit (M) to display the red image data. Moreover, the yellow back light penetrates through the cyan sub-pixel unit (C) to display the green image data.

Next, in the second color field of the N^{th} frame, the polarity reversion control signal POL is still of high level. Therefore, the data voltages of both the magenta sub-pixel unit (M) and the cyan sub-pixel unit (C) are of positive polarity. Meanwhile, the color field sequential signal FS is of low level, and the blue backlight (B) in the backlight module 170 emits light. Then, the data driving unit 130 drives the plurality of sub-pixel units in the pixel 112, according to the second part of the data driving signal, to display the second image data with the data voltage of positive polarity. In this case, the second image data comprises the blue image data. Specifically, the blue back light can penetrate through either the magenta sub-pixel unit (M) or the cyan sub-pixel unit (C) to display the blue image data.

As a result, in the N^{th} frame, the display panel 110 may display picitures of red, green and blue. Due to the visual persistence property of human eyes, a user may watch a multicolor display picture.

Further, in the first color field of the (N+1)^{th} frame, the polarity reversion control signal POL is of low level, and the data voltages of both the magenta sub-pixel unit (M) and the cyan sub-pixel unit (C) are of negative polarity. Meanwhile, the color field sequential signal FS is of high level, and the yellow backlight (Y) in the backlight module 170 emits light. Then, the data driving unit 130 drives the plurality of sub-pixel units in the pixel 112, according to the first part of the data driving signal, to display the first image data with the data voltage of negative polarity. In this case, the first image data is displayed in the same manner as in the first color field of the N^{th} frame, and thus no further description will be made herein.

Next, in the second color field of the (N+1)^{th} frame, the polarity reversion control signal POL is still of low level. Therefore, the data voltages of both the magenta sub-pixel unit (M) and the cyan sub-pixel unit (C) are of negative polarity. Meanwhile, the color field sequential signal FS is of low level, and the blue backlight (B) in the backlight module 170 emits light. Then, the data driving unit 130 drives the plurality of sub-pixel units in the pixel 112, according to the second part of the data driving signal, to display the second color field data with using the data voltage of negative polarity. In this case, the second color field data is displayed in the same manner as in the second color field of the (N+1)^{th} frame, and thus no further description will be made herein.

Thus, in the (N+1)^{th} frame, the display panel 110 can display pictures of red, green and blue. Due to the visual persistence property of human eyes, a user may watch a multicolor display picture.

In conclusion, the Nth (N+1)^{th} frame and the frame constitute one driving period of the polarity reversion control signal POL, wherein the polarity reversion control signals POL in the N^{th} frame are configured to be reversed in the (N+1)^{th} frame, so that the polarities of data voltage of the plurality of sub-pixel units in the pixel 112 are reversed. Moreover, in the two color fields of each frame, the polarities of data voltage of the sub-pixel units are identical from one field to the other. In this way, a polarity reversion of “every two color fields reversing once” is formed. Since, during either color field of two adjacent frames, the polarity of data voltage of each sub-pixel unit is reversed from one frame to the other, the waveform of the data voltage of each sub-pixel unit is symmetrical relative to a common reference voltage. As a result, the positive data voltage and the negative data voltage applied to both ends of the liquid crystal are identical with each other in terms of their absolute values, and thus residual images can be eliminated.

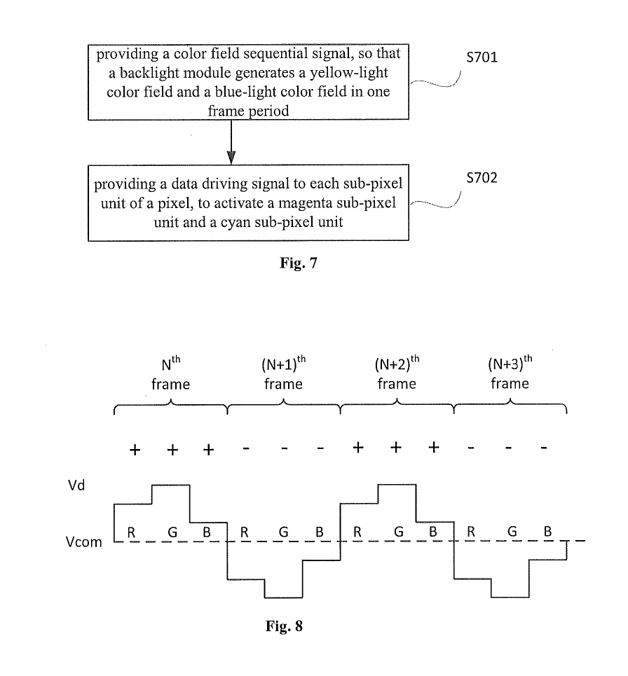

FIG. 7 is a flow chart of the driving method for the field sequential liquid crystal display device according to an embodiment. The driving method of this embodiment will be described in detail below in combination with FIG. 7.

Firstly, in step S701, a color field sequential signal FS is provided, so that the backlight module 170 can generate a plurality of color fields in one frame period respectively. In this embodiment, the backlight module 170 provides a yellow-light color field and a blue-light color field in one frame period.

Then, in step S702, a data driving signal is provided to a magenta sub-pixel unit (M) and a cyan sub-pixel unit (C) of the pixel 112 when a respective color field is valid, so as to activate the sub-pixel units corresponding to the respective color fields and the polarity of the data driving signal is periodically reversed, so that the voltage waveform of the data driving signal is symmetrical relative to a common reference voltage. The specific driving process is described above and no longer described herein.

The driving method of this embodiment may realize a reversion of “every two color field reversing once”. In the two color fields of each frame, the polarities of data voltage of the sub-pixel unit are identical from one field to the other, and in either color field of two adjacent frames, the polarity of data voltage of each sub-pixel unit is reversed from one frame to the other. As a result, the positive data voltage and negative the data voltage which are respectively applied to both ends of the liquid crystals are identical with each other in terms of their absolute values, so that residual images may be eliminated.

Those skilled in the art may understand that, a structure of M-C sub-pixel units of the pixel unit and an arrangement comprising the yellow back light and the blue back light in this embodiment may be implemented in other similar manners. For example, the pixel unit can use a sturcture of M-Y sub-pixel units, and at the same time, cyan back light and red back light can be used in an alternate manner; or the pixel unit can use a structure of C-Y sub-pixel units, and at the same time, magenta back light and green back light can be used in an alternate manner.

### Embodiment III

A pixel in the liquid crystal panel of an FSC-LCD in the prior art generally does not comprise a sub-pixel for color filtering. Instead, a backlight module for providing color fields of red, green and blue respectively displays three-color (i.e., red, green and blue) image information by means of time sequence. This embodiment provides a driving method capable of eliminating residual images.

FIG. 8 is a schematic diagram of a reversal driving manner of a FSC-LCD according to this embodiment. Under a color field sequential signal, the backlight module generates three color fields of red, green and blue in one frame period. In the three color fields of the same frame period, the polarities of data voltage of the pixel is identical from one field to another. In each color field of two adjacent frame periods, the polarity of data voltage of the pixel is opposite from one frame to the other.

Referring to FIG. 8, the Vcom therein is a reference voltage. In the R color field of the N^{th} frame, a signal voltage Vd on a pixel electrode is higher than the voltage Vcom of a common electrode COM, so that the pixel voltage applied to both ends of the liquid crystals is of positive polarity. In the following G color field, the signal voltage Vd on the pixel electrode is still higher than the voltage Vcom of the COM electrode, and thus the pixel voltage applied to both ends of the liquid crystal is still of positive polarity. Likewise, in the following B color field, the pixel voltage applied to both ends of the liquid crystal is maintained of positive polarity. Later, the pixel voltages applied to both ends of the liquid crystal in the R color field, G color field and B color field of the (N+1)^{th} frame are all maintained of negative polarity.

In this way, waveform of the data voltage of each sub-pixel unit is symmetrical relative to a common reference voltage, and thus residual image may be eliminated.

Although the implementations disclosed by the present disclosure are described above, the contents are only implementations adopted for better understanding of the present disclosure, rather than limiting the present disclosure. Any modifications and variations on the implementation form and details may be made by ones skilled in the art without departing from the disclosed spirit and scope of the present disclosure, but the patent protection scope of the present disclosure shall be subject to the scope defined by the appended claims.

1. A method for driving a field sequential liquid crystal display, comprising the steps of:
providing a color field sequential signal, so that a backlight module generates a plurality of color fields in one frame period;
providing, when each of the color fields is valid, a data driving signal to each sub-pixel unit of a pixel so as to activate the sub-pixel units corresponding to a respective color field;
wherein the polarity of the data driving signal is periodically reversed, so that voltage waveform of the data driving signal is symmetrical relative to a common reference voltage.

2. A method of claim 1, whererin two color fields are generated in one frame period,
when a first color field is valid, a first part of the data driving signal is provided to each sub-pixel unit of a pixel to activate each of the sub-pixel units, so that light of the first color field can penetrate through the sub-pixel units;
when a second color field is valid, a second part of the data driving signal is provided to each sub-pixel unit of a pixel to activate one or each of the sub-pixel units, so that light of the second color field can penetrate through the activated sub-pixel units;
wherein the first part and second part of the data driving signal have the same polarity.

3. A method of claim 2, whererin the duration when the first color field is valid is the same as the duration when the second color field is valid.

4. A method of claim 3, whererin the backlight module emits white light under the first color field, and emits one of red light, blue light and green light under the second color field; or
the backlight module emits one of magenta light, cyan light and yellow light under the first color field, and emits one of red light, blue light and green light under the second color field.

5. A method of claim 2, whererin a period of reversing polarity of the data driving signal is a multiple of the frame period.

6. A method of claim 5, whererin the backlight module emits white light under the first color field, and emits one of red light, blue light and green light under the second color field; or
the backlight module emits one of magenta light, cyan light and yellow light under the first color field, and emits one of red light, blue light and green light under the second color field.

7. A method of claim 5, whererin a period of reversing polarity of the data driving signal is the same as the frame period.

8. A method of claim 7, whererin the backlight module emits white light under the first color field, and emits one of red light, blue light and green light under the second color field; or
the backlight module emits one of magenta light, cyan light and yellow light under the first color field, and emits one of red light, blue light and green light under the second color field.

9. A method of claim 7, whererin the polarity of the data driving signal is periodically reversed under the control of a polarity reversion control signal.

10. A method of claim 9, whererin the backlight module emits white light under the first color field, and emits one of red light, blue light and green light under the second color field; or
the backlight module emits one of magenta light, cyan light and yellow light under the first color field, and emits one of red light, blue light and green light under the second color field.

11. A method of claim 2, whererin the backlight module emits white light under the first color field, and emits one of red light, blue light and green light under the second color field; or
the backlight module emits one of magenta light, cyan light and yellow light under the first color field, and emits one of red light, blue light and green light under the second color field.

12. A method of claim 1, whererin at least one of the sub-pixel units is a transparent sub-pixel unit.

13. A method of claim 1, whererin the sub-pixel units include two of a magenta sub-pixel unit, a cyan sub-pixel unit, and a yellow sub-pixel unit; or
the sub-pixel units include two of a red sub-pixel unit, a green sub-pixel unit, and a blue sub-pixel unit.

14. A liquid crystal display device, comprising:
a time sequence control unit, for providing a color field sequential signal so that a backlight module generates a plurality of color fields in one frame period; and
a data driving unit, for providing, when each of the color fields is valid, a data driving signal, to each sub-pixel unit of a pixel so as to activate the sub-pixel units corresponding to a respective color field;
wherein the time sequence control unit also provides a polarity reversion control signal for periodically reversing the polarity of the data driving signal, so that voltage waveform of the data driving signal is symmetrical relative to a common reference voltage.

15. A liquid crystal display device of calim 14, wherein the backlight module generates two color fields in one frame period,
when a first color field is valid, the data driving unit provides a first part of the data driving signal to each sub-pixel unit of a pixel to activate each of the sub-pixel units, so that light of the first color field can penetrate through the sub-pixel units;
when a second color field is valid, the data driving unit provides a second part of the data driving signal to each sub-pixel unit of a pixel to activate one or each of the sub-pixel units, so that light of the second color field can penetrate through the activated sub-pixel units;
wherein the first part and second part of the data driving signal have the same polarity.

16. A liquid crystal display device of calim 15, wherein the duration when the first color field is generated by the backlight module is the same as the duration when the second color field is generated by the backlight module.

17. A liquid crystal display device of calim 15, wherein a period in which the polarity of the data driving signal is reversed under the polarity reversion control signal is a multiple of the frame period.

18. A liquid crystal display device of calim 17, wherein the period in which the polarity of the data driving signal is reversed under the polarity reversion control signal is the same as the frame period.

19. A liquid crystal display device of calim 14, wherein at least one of the sub-pixel units is a transparent sub-pixel unit.

20. A liquid crystal display device of calim 14, wherein the sub-pixel units include two of a magenta sub-pixel unit, a cyan sub-pixel unit, and a yellow sub-pixel unit; or
the sub-pixel units include two of a red sub-pixel unit, a green sub-pixel unit, and a blue sub-pixel unit.
